(19) United States
(12) Patent Application Publication
(10) Pub. No.: US 2026/0145413 A1
(43) Pub. Date: May 28, 2026

(54) METHOD OF PRODUCING LAMINATE SHEET AND LAMINATE SHEET PRODUCING DEVICE

(71) Applicant: TOYOTA BOSHOKU KABUSHIKI KAISHA, Aichi-ken (JP)

(72) Inventors: Mitsuru SUZUKI, Toyota-shi (JP); Keita HONTANI, Toyota-shi (JP); Noriko FUJITA, Osaka-shi (JP)

(73) Assignee: TOYOTA BOSHOKU KABUSHIKI KAISHA, Aichi-ken (JP)

(21) Appl. No.: 19/392,386

(22) Filed: Nov. 18, 2025

(30) Foreign Application Priority Data
Nov. 22, 2024 (JP) 2024-203788

(51) Int. Cl. B32B 37/00; B32B 37/10; B32B 38/18

(52) U.S. Cl. CPC B32B 37/025; B32B 37/1045; B32B 38/1808

(57) ABSTRACT

A method of producing a laminate sheet including separately holding an upper layer side sheet group and a lower layer side sheet group, pulling the upper layer side sheet group to a position above a table separator of a table and pulling the lower layer side sheet group to a position below the table separator at a same time and spreading the sheet members on the table, moving a transfer device toward the table, according to the moving of the transfer device, moving a transfer device separator of the transfer device closer to the table separator and replacing the table separator with the transfer device separator.

### CROSS REFERENCE TO RELATED APPLICATION

This application claims priority from Japanese Patent Application No. 2024-203788 filed on Nov. 22, 2024. The entire contents of the priority application are incorporated herein by reference.

### TECHNICAL FIELD

The present technology described herein relates to a method of producing a laminate sheet and a laminate sheet producing device for producing a laminate sheet.

### BACKGROUND

There has been known a method of producing a laminate sheet (a panel formed of laminate composite material). The panel (a laminate blank) includes a core layer, inner layers of continuous-fiber unidirectional reinforced polypropylene that are stacked on two surfaces of the core layer, respectively, and outermost fiber reinforced layers stacked on the inner layers, respectively. The layers are provided on rolls and pulled out to cut to the size of the blank. The layers are then placed in stack to form the blank with press molding.

### SUMMARY

In the above method of producing the laminate sheet, the sheet members of the layers are pulled out sequentially and stacked. Therefore, to produce one laminate sheet, several times of spreading is necessary. If all the sheet members may be previously stacked, the sheet members of the layers can be collectively held and pulled out at once. However, in the press molding, only one of the sheet members such as a skin member needs to be held with being tensioned. In such a case, the spreading needs to be performed at least two times to hold the one of the sheet members and the others separately. In producing the laminate sheet, the cycle time becomes longer as the number of times of spreading increases.

An object of the present technology described herein is to shorten a cycle time in producing a laminate sheet.

A method of producing a laminate sheet of this disclosure includes supplying sheet members in a first transfer direction to a supply position where the sheet members are arranged in an upper bottom direction, separately holding an upper layer side sheet group including at least one of the sheet members that is on an upper layer side and a lower layer side sheet group including at least another one of the sheet members that is on a lower layer side than the upper layer side sheet group, pulling the upper layer side sheet group in the first transfer direction from the supply position to a position above a table separator of a table and pulling the lower layer side sheet group in the first transfer direction from the supply position to a position below the table separator at a same time and spreading the sheet members including the upper layer side sheet group and the lower layer side sheet group on the table with the table separator being in a space between the upper layer side sheet group and the lower layer side sheet group, moving a transfer device toward the table in a second transfer direction that is an opposite direction from the first transfer direction, according to the moving of the transfer device in the second transfer direction, moving a transfer device separator of the transfer device closer to the table separator and replacing the table separator with the transfer device separator, transferring the upper layer side sheet group and the lower layer side sheet group in the first direction from the table to a press molding device with the transfer device holding an edge portion of the upper layer side sheet group and an edge portion of the lower layer side sheet group separately, and press molding the upper layer side sheet group and the lower layer side sheet group with the upper layer side sheet group and the lower layer side sheet group being held by the transfer device with different forces and molding a laminate sheet.

A laminate sheet producing device includes a supply section configured to supply sheet members in a first transfer direction to a supply position where the sheet members are arranged in an upper-bottom direction, a spreading device including a table to which the sheet members are transferred from the supply section, a first holding portion, a second holding portion, and a moving device, and a transfer device configured to be movable in the first transfer direction and a second transfer direction that is an opposite direction from the first transfer direction and to transfer the sheet members in the first transfer direction from the spreading device to a press molding device. The table includes a table body, a table separator disposed above and spaced from the table body, and a separator moving device configured to move the table separator. The first holding portion holds an upper layer side sheet group including at least one of the sheet members that is on an upper layer side at the supply position. The second holding portion holds a lower layer side sheet group including at least another one of the sheet members that is below the upper layer side sheet group at the supply position. The moving device is configured to move the first holding portion and the second holding portion at a same time and move the upper layer side sheet group in the first transfer direction to a position above the table separator and move the lower layer side sheet group in the first transfer direction to a position below the table separator at a same time, and the table separator is in a space between the upper layer side sheet group and the lower layer side sheet group. The transfer device includes a transfer device separator, an upper holding portion that holds the upper layer side sheet group above the transfer device separator, and a lower holding portion that holds the lower layer side sheet group below the transfer device separator. According to movement of the transfer device in the second transfer direction toward the table, the table separator is moved by the separator moving device out of the space and the transfer device separator is moved into the space and the upper holding portion holds the upper layer side sheet group above the transfer device separator and the lower holding portion holds the lower layer side sheet group below the transfer device separator.

According to the present disclosure, a cycle time in producing a laminate sheet can be shortened.

### BRIEF DESCRIPTION OF THE DRAWINGS

FIG. 1 is a schematic view of a ceiling member producing system according to one embodiment.

FIG. 2 is a cross-sectional view of a ceiling member.

FIG. 3 is an enlarged cross-sectional view illustrating sheet members that are at a supply position.

FIG. 4 is a side view of a table on which the sheet members are spread.

FIG. 5 is a view illustrating a holding device seen from a first transfer direction.

FIG. 6 is a side view seen from the first transfer direction and illustrating the table on which the sheet members are spread.

FIG. 7 is an upper view illustrating a surrounding portion of a cutting device.

FIG. 8 is a side view illustrating the table that is moved downward.

FIG. 9 is a view seen from the first transfer direction and illustrating a multi-level chuck included in a transfer device.

FIG. 10 is a cross-sectional view illustrating portions of the table and the transfer device in a separator moving process.

FIG. 11 is a plan view illustrating portions of the table and the transfer device in a separator moving process.

FIG. 12 is a view seen from the first transfer direction and illustrating the transfer device holding the sheet members.

FIG. 13 is a view seen from the first transfer direction and illustrating a press molding device where the transfer device holding the sheet members is arranged.

FIG. 14 is a view seen from the first transfer direction and illustrating a skin sheet member being tensioned.

FIG. 15 is a block diagram of the ceiling member producing system.

### DETAILED DESCRIPTION

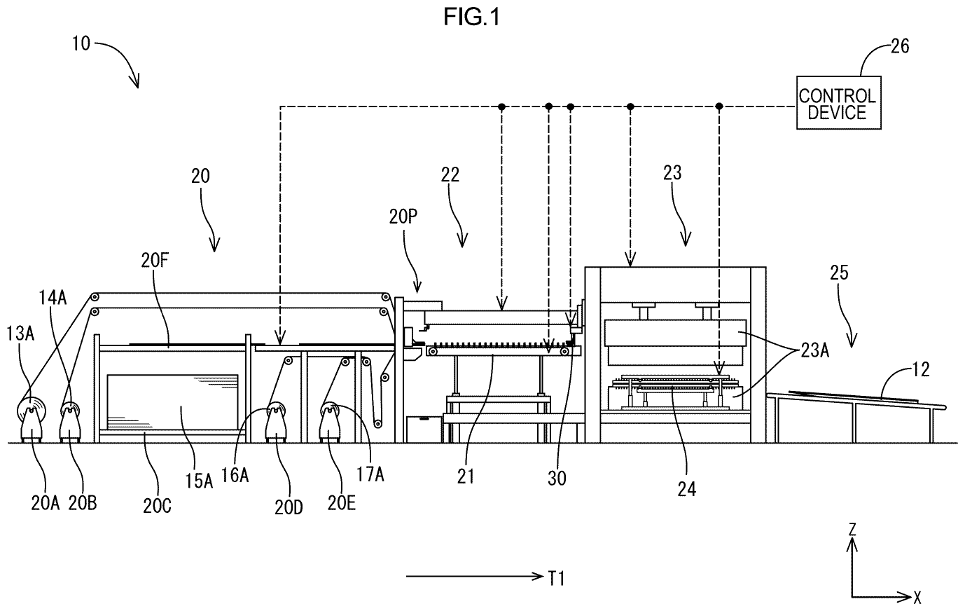

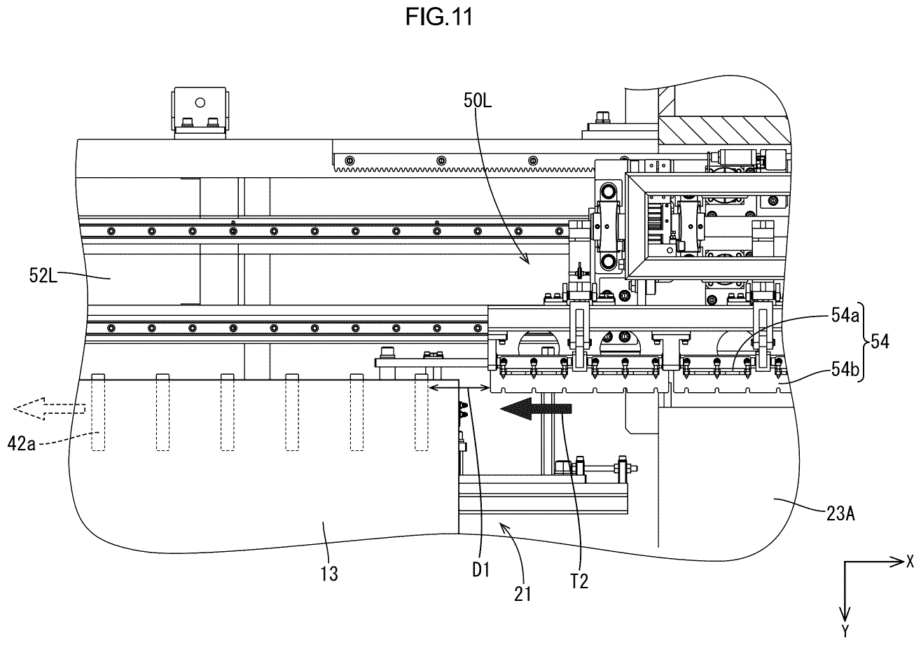

A ceiling member producing system 10 according to one embodiment will be described with reference to FIGS. 1 to 15. The ceiling member producing system 10 of this embodiment is for producing a ceiling member 12, which is a vehicular interior component, and includes devices that are arranged in a line as illustrated in FIG. 1. In some of the drawings, the arrows X, Y, and Z represent a direction in which material is transferred in the ceiling member producing system 10 (a first transfer direction T1), a width direction of the ceiling member producing system 10, and an upper-bottom direction of the ceiling member producing system 10, respectively.

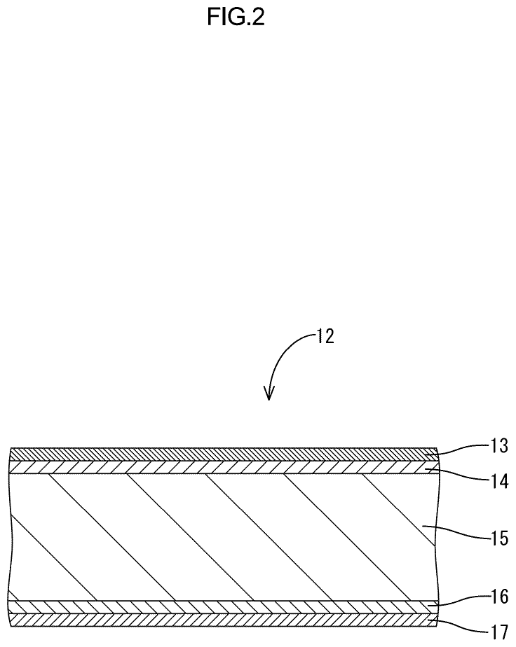

As illustrated in FIG. 2, the ceiling member 12 produced by the ceiling member producing system 10 of this embodiment includes a skin member 13, a first glass fiber mat 14, a urethane mat 15, a second glass fiber mat 16, and scrim 17 that are stacked in this order from an upper layer side (a design surface side). The sheet members of the skin member 13, the first glass fiber mat 14, the urethane mat 15, the second glass fiber mat 16, and the scrim 17 are stacked and the stacked member is molded with pressing. The stacked member is cut and molded into a predetermined shape at the same time and a laminate sheet is obtained. The obtained laminate sheet corresponds to the ceiling member 12.

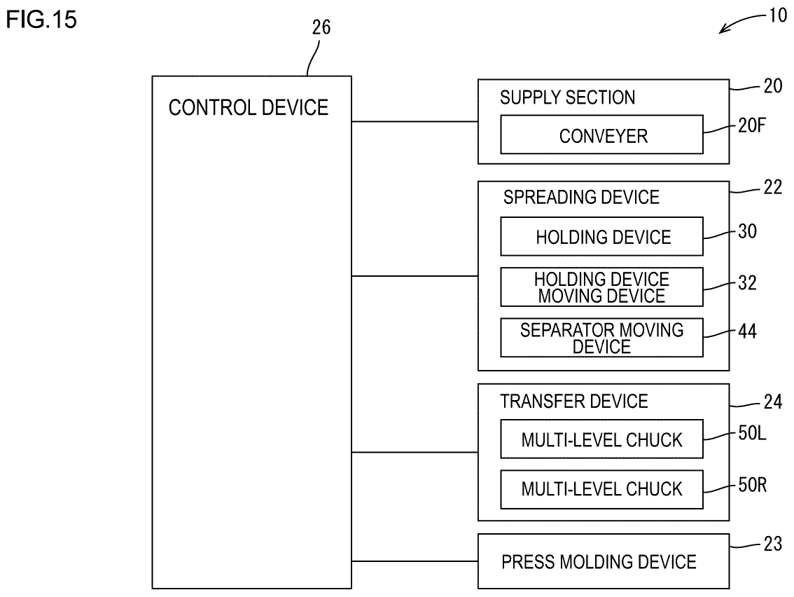

As illustrated in FIG. 1, the ceiling member producing system 10 of this embodiment includes a supply section 20 that supplies the sheet members 13A, 14A, 15A, 16A, 17A, a spreading device 22 that receives the sheet members 13A, 14A, 15A, 16A, 17A from the supply section 20 and spreads them onto a table 21, a press molding device 23 that molds the sheet members 13A, 14A, 15A, 16A, 17A with pressing and forms the ceiling member 12, a transfer device 24 that transfers the sheet members 13A, 14A, 15A, 16A, 17A from the spreading device 22 to the press molding device 23, an exit section 25 where the ceiling member 12 molded by the press molding device 23 is disposed, and a control device 26 that controls the ceiling member producing system 10. The transfer device 24 is movable in the first transfer direction T1 and a second transfer direction T2 that is an opposite direction from the first transfer direction T1. As illustrated in FIG. 15, the supply section 20, the spreading device 22, the press molding device 23, and the transfer device 24 are connected to the control device 26 and are controlled by the control device 26.

### Supply Process: Configuration of Supply Section

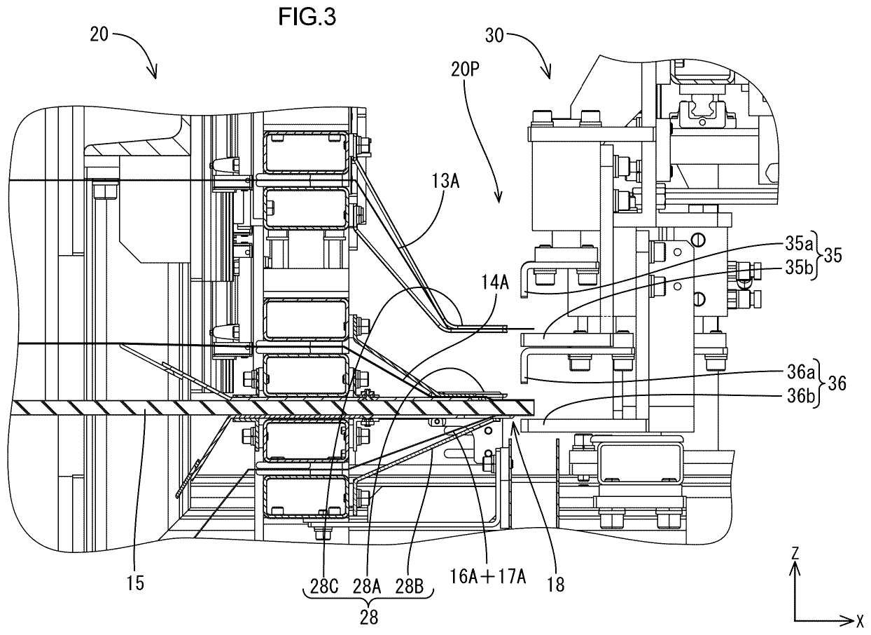

The supply section 20 includes a skin sheet member set section 20A where a skin sheet member 13A is rolled, a first glass fiber mat sheet member set section 20B where a first glass fiber mat sheet member 14A is rolled, an urethane mat sheet member storing section 20C where urethane mat sheet members 15A of a predetermined size are placed, a second glass fiber mat sheet member set section 20D where a second glass fiber mat sheet member 16A is rolled, and a scrim sheet member set section 20E where a scrim sheet member 17A is rolled. The supply section 20 further includes a conveyer 20F that transfers one of the urethane mat sheet members 15A to a supply position 20P. With the urethane mat sheet member 15A being at the supply position 20P, the lower stream side end portion of the urethane mat sheet member 15A projects from the supply section 20 toward the spreading device 22 as illustrated in FIG. 3.

The supply section 20 keeps the skin sheet member 13A, the glass fiber mat sheet members 14A, 16A, and the scrim sheet member 17A that are pulled out such that one ends of the skin sheet member 13A and the first glass fiber mat sheet member 14A are above the urethane mat sheet member 15A and the second glass fiber mat sheet member 16A and the scrim sheet member 17A are under the urethane mat sheet member 15A. Namely, as illustrated in FIG. 3, with the sheet members 13A, 14A, 15A, 16A, 17A being at the supply position 20P, the one ends of the sheet members 13A, 14A, 15A, 16A, 17A are arranged in the upper-bottom direction. More specifically, the supply section 20 includes a guide 28 that guides the one ends of the sheet members to predetermined level positions. The guide 28 includes a first guide 28A, a second guide 28B, and a third guide 28C. The first guide 28A guides the first glass fiber mat sheet member 14A to be overlapped with and on the urethane mat sheet member 15. The second guide 28B guides the second glass fiber mat sheet member 16A and the scrim sheet member 17A, which are overlapped, to be overlapped with and under the urethane mat sheet member 15. The third guide 28C guides the skin sheet member 13A to the supply position 20P that is above and spaced from the first glass fiber mat sheet member 14A.

### Spreading Process and Cutting Process: Configuration of Spreading Device

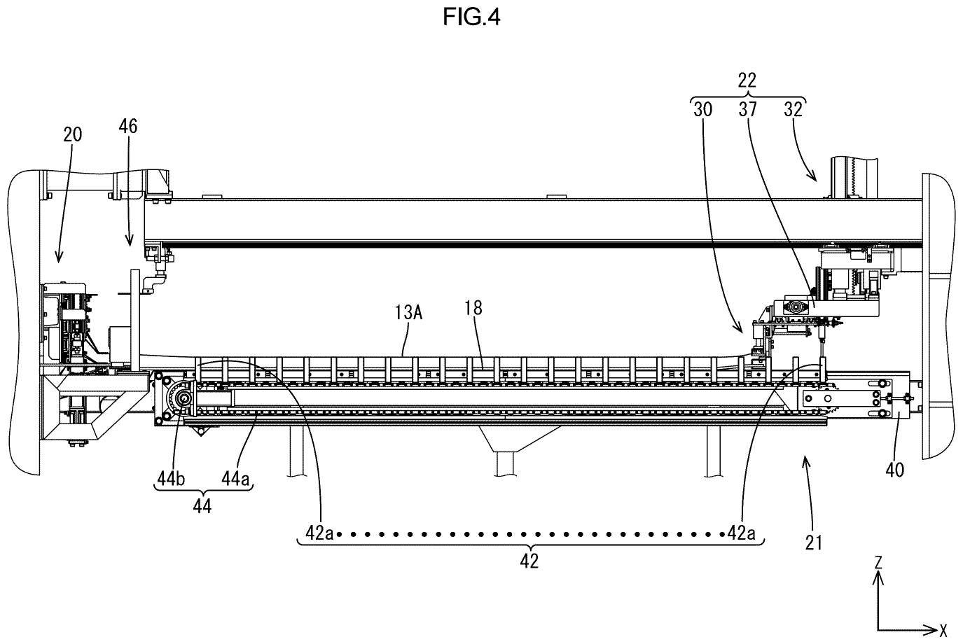

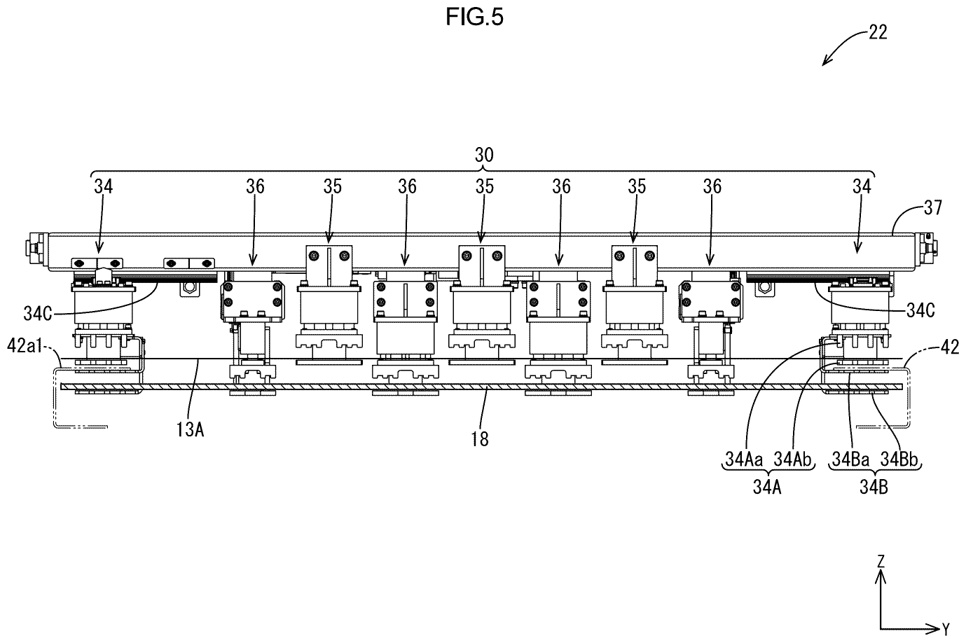

As illustrated in FIG. 4, the sheet members 13A, 14A, 15A, 16A, 17A that are disposed at the supply position 20P are pulled onto the table 21 by the spreading device 22. The spreading device 22 includes a holding device 30, a frame 37 to which the holding device 30 is fixed, and a holding device moving device 32. The holding device 30 holds the one ends of the sheet members 13A, 14A, 15A, 16A, 17A at the supply position 20P. The holding device moving device 32 moves the holding device 30 in the first transfer direction T1. As illustrated in FIG. 5, the holding device 30 includes first chucks 34, second chucks 35, and third chucks 36 (a total of the chucks is nine in this embodiment). The first chucks 34, the second chucks 35, and the third chucks 36 are fixed to the frame 37. With being controlled by the control device 26, the holding device moving device 32 is configured to move the frame 37 in the first transfer direction T1 to move all the chucks including the first chucks 34, the second chucks 35, and the third chucks 36 at the same time.

The first chucks 34 are disposed at two ends with respect to the width direction (along the Y-direction), respectively. The first chuck 34 includes an upper chuck 34A on a relatively upper side and a lower chuck 34B on a lower side. The upper chuck 34A holds the skin sheet member 13A, which is at the supply position 20P, and the lower chuck 34B collectively holds the first glass fiber mat sheet member 14A, the urethane mat sheet member 15A, the second glass fiber mat sheet member 16A, and the scrim sheet member 17A, which are at the supply position 20P. The upper chuck 34A includes chuck jaws 34Aa and jaw receivers 34Ab. With the chuck jaws 34Aa being moved downward toward the jaw receivers 34Ab, the upper chuck 34A holds the skin sheet member 13A. The lower chuck 34B includes two holding plates 34Ba, 34Bb. With the upper holding plate 34Ba being moved downward toward the lower holding plate 34Bb, the lower chuck 34B holds the sheet members. The two holding plates 34Ba, 34Bb of the lower chuck 34B are supported at an end portion of the first chuck 34 closer to a middle of the spreading device 22 with respect to the width direction. A space between the two holding plates 34Ba, 34Bb and a space between the lower chuck 34B and the upper chuck 34A open to an outer side of the spreading device 22 with respect to the width direction (the Y direction) and also open to both sides with respect to the first transfer direction T1 (the X direction). The first chuck 34 further includes a guide 34C and is configured to be movable in the width direction along the guide 34C. The position of the first chuck 34 can be adjusted according to the width of the sheet member.

The second chucks 35 and the third chucks 36 are alternately arranged between the two first chucks 34. The second chucks 35 are arranged upper than the third chucks 36. The second chucks 35 are disposed at a same level as the upper chucks 34A of the first chucks 34 and hold the skin sheet member 13A. The third chucks 36 are disposed at a same level as the lower chucks 34B of the first chucks 34 and collectively hold the first glass fiber mat sheet member 14A, the urethane mat sheet member 15A, the second glass fiber mat sheet member 16A, and the scrim sheet member 17A. As illustrated in FIG. 3, the second chuck 35 includes a chuck jaw 35a and a jaw receiver 35b and the third chuck 36 includes a chuck jaw 36a and a jaw receiver 36b. With the chuck jaws 35a, 36a being moved downward toward the jaw receivers 35b, 36b, the second chucks 35 hold the skin sheet member 13A and the third chucks 36 collectively hold the first glass fiber mat sheet member 14A, the urethane mat sheet member 15A, the second glass fiber mat sheet member 16A, and the scrim sheet member 17A.

The skin sheet member 13A corresponds to an upper layer side sheet group including at least one sheet member of the sheet members that are at the supply position 20P. The at least one sheet member is an upper layer side one of the sheet members. The first glass fiber mat sheet member 14A, the urethane mat sheet member 15A, the second glass fiber mat sheet member 16A, and the scrim sheet member 17A correspond to a lower layer side sheet group 18 that includes at least one sheet member that is a lower layer side one of the sheet members. The upper chuck 34A of the first chuck 34 and the second chuck 35 correspond to a first holding portion that holds the skin sheet member 13A, which corresponds to the upper layer side sheet group. The lower chuck 34B of the first chuck 34 and the third chuck 36 correspond to a second holding portion that holds the lower layer side sheet group 18.

In the spreading device 22, the first holding portion that holds the skin sheet member 13A and the second holding portion that holds the lower layer side sheet group 18 are moved by the holding device moving device 32 toward the downstream side in the first transfer direction T1 at the same time. Thus, the skin sheet member 13A and the lower layer side sheet group 18 are pulled onto the table 21.

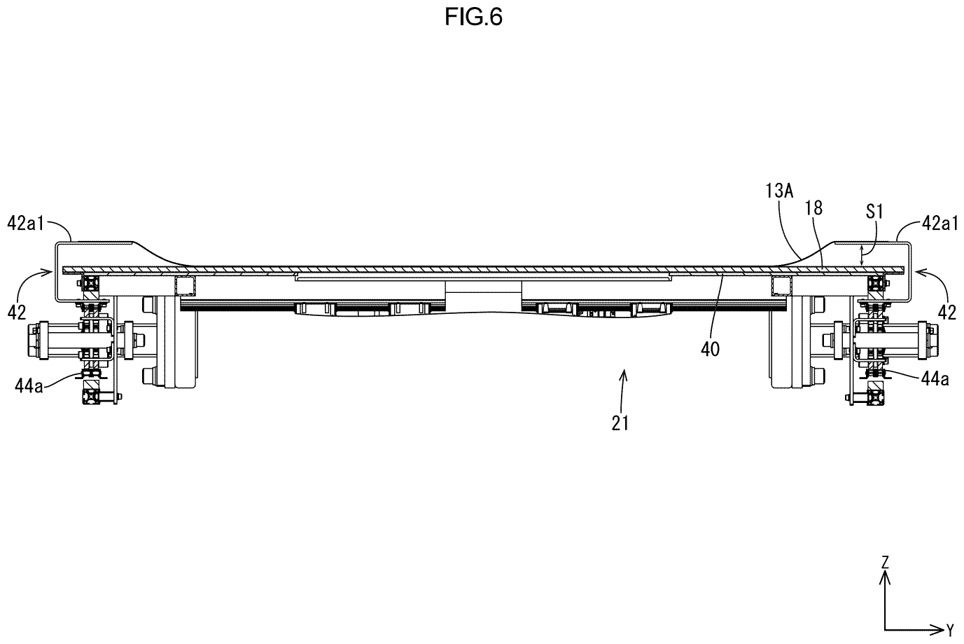

As illustrated in FIGS. 4 and 6, the table 21 includes a table body 40, table separators 42, and a separator moving device 44 (a separator retracting device) that moves the table separator 42. The table separators 42 are disposed on two edges of the table body 40 with respect to the width direction, respectively. As illustrated in FIG. 4, the separator moving device 44 includes a gear 44b and a conveyer chain 44a of a caterpillar chain and passes around the gears 44b. As illustrated in FIGS. 4 and 6, the separator moving device 44 is under the table body 40 and extends along an edge portion of the table body 40 with respect to the width direction. The table separator 42 includes support members 42a. The support members 42a are fixed to the conveyer chain 44a. Particularly in the state illustrated in FIG. 4, the support members 42a are fixed to an upper portion of the conveyer chain 44a that is upper than the gear 44b. The support members 42a are arranged at predefined intervals. The support member 42a has a U-shaped member. As illustrated in FIG. 6, the support member 42a is fitted to the edge of the table body 40 and extends in a U shape extending from the lower side to the upper side of the table body 40. The portion of the support member 42a that is on the upper side of the table body 40 is defined as a support portion 42a1. The support portion 42a1 is away from and above the table body 40. A space S1 is between the upper layer side sheet group and the lower layer side sheet group 18 disposed on the table body 40.

In the spreading device 22, the first holding portion (the upper chucks 34A and the second chucks 35) is above the support portion 42a1 and the second holding portion (the lower chucks 34B and the third chucks 36) is between the table body 40 and the support portion 42a1. Namely, the spreading device 22 pulls the skin sheet member 13A and the lower layer side sheet group 18 such that two edge portions of the skin sheet member 13A with respect to the width direction are above the support portion 42a1 and two edge portions of the lower layer side sheet group 18 is under the support portion 42a1. As previously described, the lower chuck 34B is supported at end portion of the first chuck 34 closer to a middle of the spreading device 22 with respect to the width direction and the lower chuck 34B is open to the outer side of the spreading device 22 with respect to the width direction and also open to the both sides with respect to the first transfer direction T1. With such a configuration, as illustrated in FIG. 5, when the holding device 30 moves in the first transfer direction T1 (the X direction), the table separators 42 (the support members 42a) can be inserted between the upper chuck 34A and the lower chuck 34B.

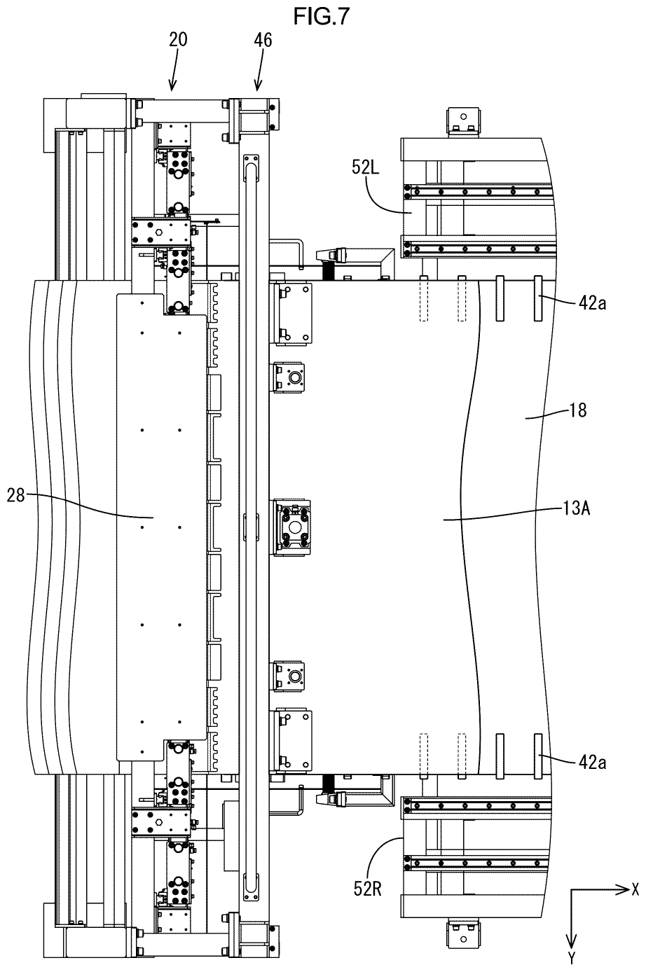

As illustrated in FIG. 7, a cutting device 46 is disposed between the supply section 20 and the table 21. The skin sheet member 13A and the lower layer side sheet group 18 are held and pulled out by the spreading device 22 to have a predefined length. Then, the skin sheet member 13A, and the first glass fiber mat sheet member 14A, the second glass fiber mat sheet member 16A, the scrim sheet member 17A of the lower layer side sheet group 18 are collectively cut by the cutting device 46. The skin sheet member 13A and the lower layer side sheet group18 that are cut to have the predefined length are pulled out to a predefined position and released from the holding device 30. Thus, the spreading process is finished.

### Separator Moving Process

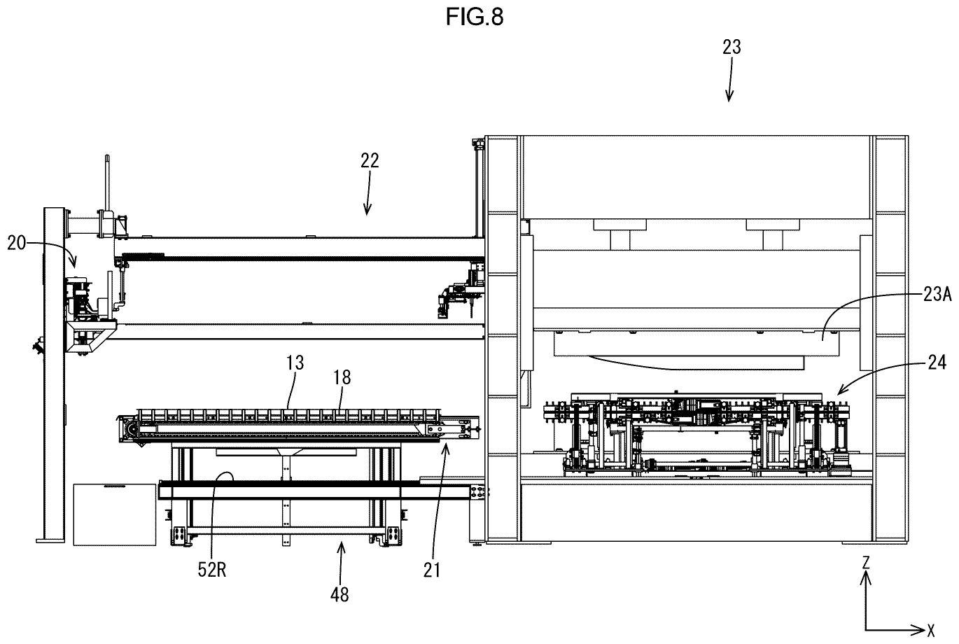

After the spreading process, the table 21 is moved such that the table 21 and the press molding device 23 are at the same level. As illustrated in FIG. 8, an elevator 48 is connected to the table 21 and moves the table 21 that is at the level of the supply position 20P of the supply section 20 down to the level of the transfer device 24. The transfer device 24 is movable in the direction along the X direction (in the first transfer direction T1 and the second transfer direction T2) for transferring the skin sheet member 13A and the lower layer side sheet group 18 on the table 21 to the press molding device 23.

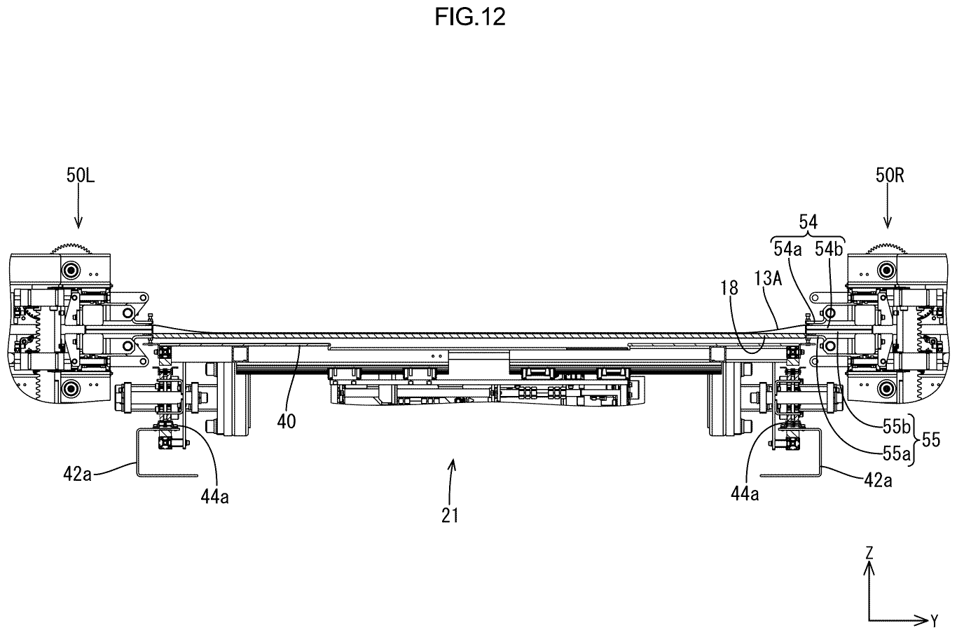

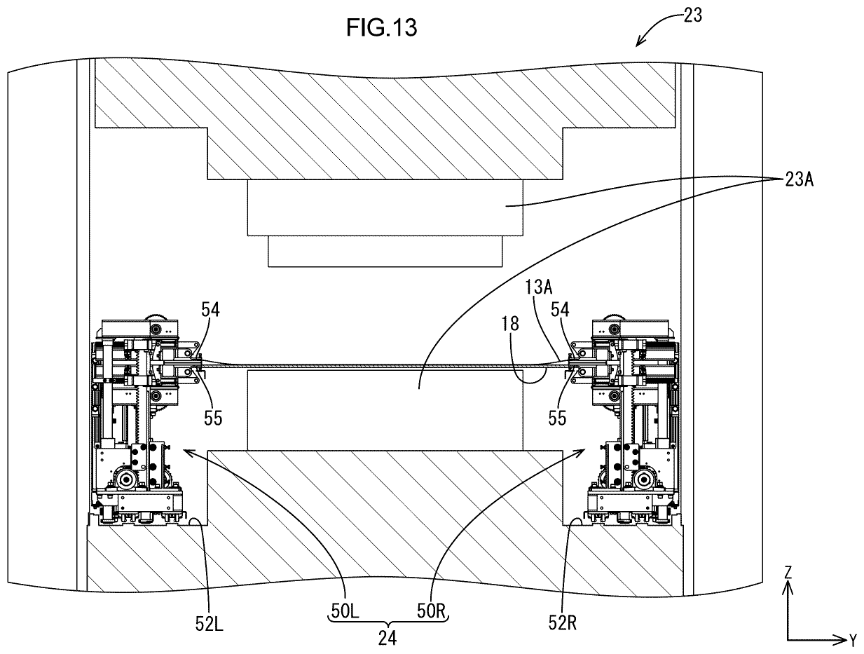

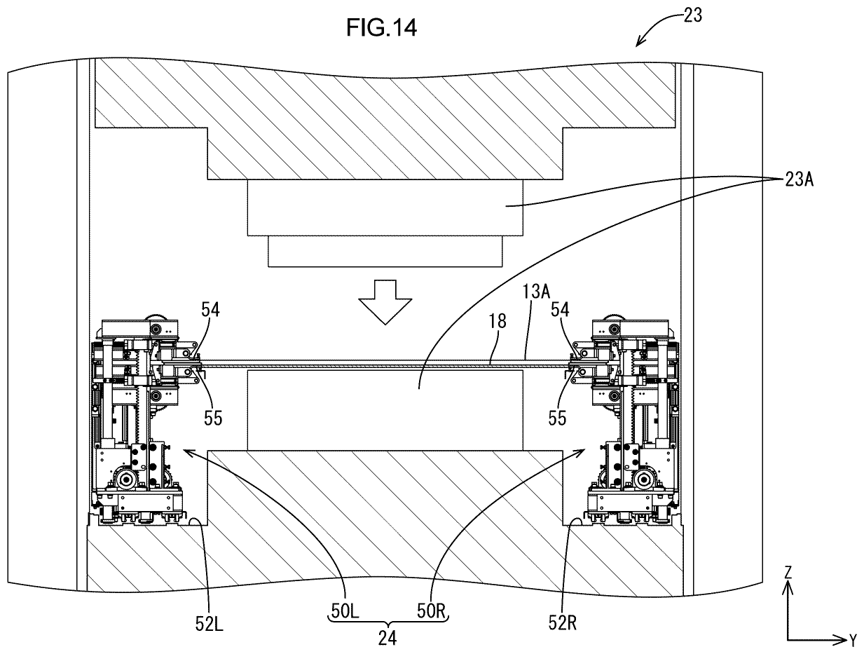

The transfer device 24 will be described. As illustrated in FIG. 12, the transfer device 24 includes a pair of multi-level chucks 50L, 50R. As illustrated in FIGS. 13 and 14, a pair of rails 52L, 52R extend along the first transfer direction T1 and sandwich the table 21 and a molding die 23A of the press molding device 23. The multi-level chucks 50L, 50R moves on the rails 52L, 52R, respectively. Each of the multi-level chucks 50L, 50R includes an upper chuck 54 (an upper holder) that is on relatively an upper side and holds the skin sheet member 13A and a lower chuck 55 (a lower holder) that is on relatively a lower side and holds the lower layer side sheet group 18.

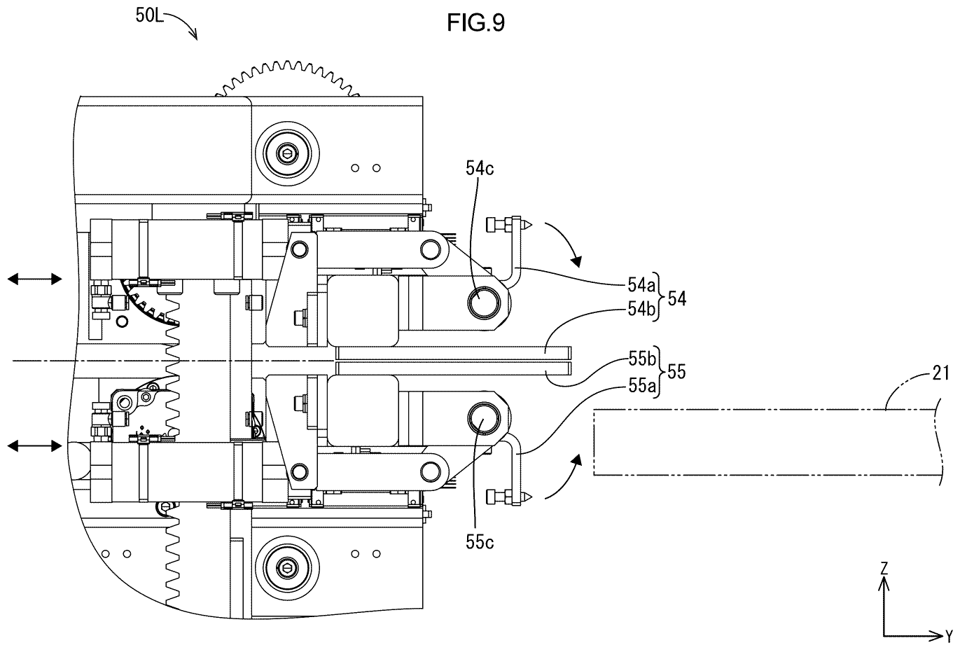

As illustrated in FIG. 9, the upper chuck 54 includes an upper chuck jaw 54a and an upper jaw receiver 54b and the upper chuck jaw 54a is disposed above the upper jaw receiver 54b. With the upper chuck jaw 54a being rotated around a rotation shaft 54c, the upper chuck jaw 43a moves downward and the skin sheet member 13A that is on the upper jaw receiver 43b is sandwiched by the upper chuck jaw 43a and the upper jaw receiver 43b. On the other hand, the lower chuck 55 includes a lower chuck jaw 55a and a lower jaw receiver 55b and the lower chuck jaw 55a is disposed under the lower jaw receiver 55b. With the lower chuck jaw 55a being rotated around a rotation shaft 55c, the lower chuck jaw 55a moves upward and the lower layer side sheet group 18 that is under the lower jaw receiver 55b is sandwiched by the lower chuck jaw 55a and the lower jaw receiver 55b. The upper jaw receiver 54b and the lower jaw receiver 55b project toward a middle of the transfer device 24 with respect to the width direction and are adjacent to and parallel to each other. In a normal state illustrated in FIG. 9, with the upper chuck jaw 54a extending upward and the lower chuck jaw 55a extending downward, the upper jaw receiver 54b and the lower jaw receiver 55b project further toward the middle of the transfer device 24 with respect to the width direction than the upper chuck jaw 54a and the lower chuck jaw 55a. Each of the multi-level chucks 50L, 50R is configured to move the upper chuck 54 and the lower chuck 55 separately in the width direction.

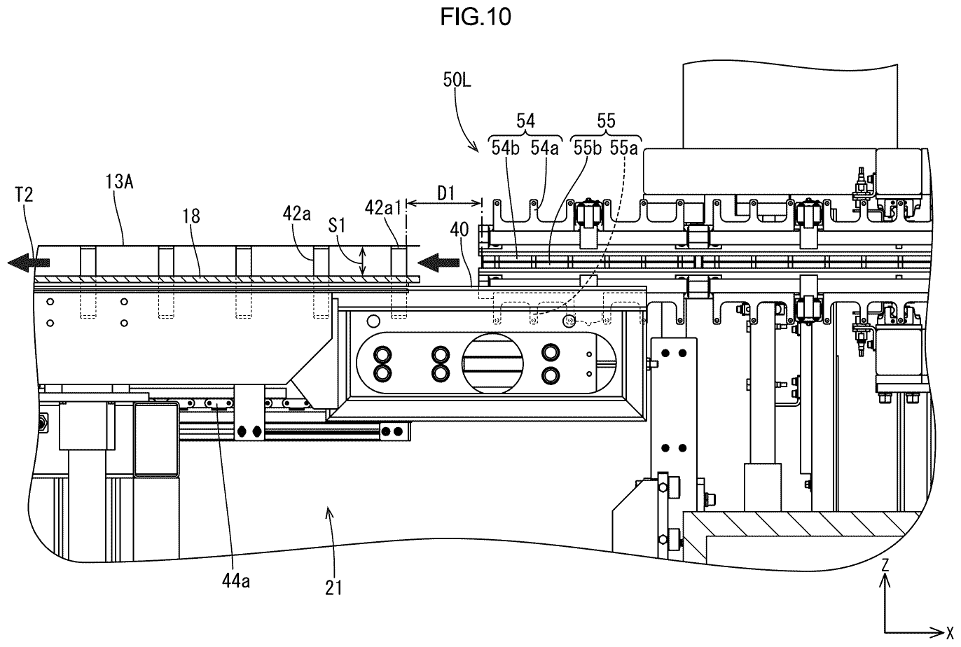

The movement of the table 21 and the transfer device 24 will be described. As illustrated in FIGS. 8 and 10, the table 21 is moved downward with control by the control device 26 until the upper jaw receiver 54b and the lower jaw receiver 55b are between the table body 40 and the support portion 42a1 of the support member 42a. Subsequently, according to control by the control device 26, with the transfer device 24 being moved closer to the table 21 in the second transfer direction T2, the table separator 42 is moved out from the upper side of the table 21. Specifically, the control device 26 detects a position of the upper jaw receiver 54a and the lower jaw receiver 55b, which are on the most upstream side in the first transfer direction T1, and a position of the support member 42a that is on the most downstream side in the first transfer direction. The transfer device 24 moves closer to the table 21 in the second transfer direction T2 and when the control device 26 determines that a distance between the position of the upper jaw receiver 54a and the lower jaw receiver 55b, which are on the most upstream side in the first transfer direction T1, and the position of the support member 42a, which is on the most downstream side in the first transfer direction, is a predefined distance D1 (for instance 5 cm to 10 cm), the control device 26 controls the conveyer chain 44a to move the support members 42a in the second transfer direction T2 and also controls the transfer device 24 to move the upper chuck 54 and the lower chuck 55 in the second transfer direction T2 with keeping the distance D1. The conveyer chain 44a is rotated in a clockwise direction in FIG. 4 and accordingly, the support members 42a are moved from the upper position that is above the gear 44b to the lower position that is below the gear 44b. Therefore, the tape separator 42 is moved out from the upper surface of the table body 40. On the other hand, the upper jaw receiver 54b and the lower jaw receiver 55b of the transfer device 24 are inserted in the space S1 between the skin sheet member 13A and the lower layer side sheet group 18. A separator between the skin sheet member 13A and the lower layer side sheet group 18 is switched from the table separator 42 to the upper jaw receiver 54b and the lower jaw receiver 55b, which correspond to a transfer device separator.

### Transfer Process and Pressing Process

After the table separator 42 moves to the lower position below the gear 44b as illustrated in FIG. 12, the skin sheet member 13A is held by the upper chuck 54 and the lower layer side sheet group 18 is held by the lower chuck 55. With the control by the control device 26, the transfer device 24 that holds edge portions of the skin sheet member 13A and the lower layer side sheet group 18 with respect to the width direction, is moved in the first transfer direction T1 toward the press molding device 23. Then, the transfer device 24 holding the skin sheet member 13A and the lower layer side sheet group 18 separately is in the press molding device 23 as illustrated in FIG. 13. In press molding, the skin sheet member 13A is necessarily tensioned with edge portions being pulled such that wrinkles are not created on the surface. As illustrated in FIG. 14, with the upper chuck 54 being moved outward with respect to the width direction, the sheet members are molded with pressing with the skin sheet member 13A being tensioned from two sides with respect to the width direction. Thus, the ceiling member 12 is formed.

As previously described, according to the method of producing the ceiling member 12 and the ceiling member producing system 10 of this embodiment, in the pressing process, the press molding is performed with the skin sheet member 13A, which is the upper layer side sheet group, and the lower layer side sheet group 18 being separately held. This embodiment includes the table separator 42 and the table separator 42 is replaced with the upper jaw receiver 54b and the lower jaw receiver 55b of the transfer device 24. With such a configuration, the operation of spreading is performed only once in the spreading process and the cycle time required for producing one ceiling member 12 can be shortened. The sheet members 13A, 14A, 16A, 17A that are rolled can be collectively pulled and cut once. This further shortens the cycle time.

In the pressing process, the upper layer side sheet group and the lower layer side sheet group 18 are molded with pressing with being held separately with different forces. To hold the upper layer side sheet group and the lower layer side sheet group 18 with different forces, forces to tension the sheet groups may be different, tension force may be applied to only one of the sheet groups, or forces to hold the sheet groups may be different.

### Other Embodiments

The technology described herein is not limited to the embodiment described above with reference to the drawings. The technology described herein may be modified within the technical scope. The following embodiments may be included in the technical scope.

In the above embodiment, the upper layer side sheet group only includes the skin sheet member 13A but may include two or more sheet members.

In the above embodiment, the table separator 42 that is fixed to the conveyer chain 44a is moved by the rotation of the conveyer chain 44a and is moved from the upper surface of the table 21. However, each of the support members of the table separator may be moved separately and the support members may be moved downward sequentially and the transfer device separator may be inserted in a space between the upper layer side sheet group and the lower layer side sheet group.

In the above embodiment, the upper jaw receiver 54b of the upper chuck 54, which corresponds to the upper holding portion, and the lower jaw receiver 55b of the lower chuck 55, which correspond to the lower holding portion, correspond to the transfer device separator. However, the transfer device separator may be included separately from the upper holding portion and the lower holding portion.

In the above embodiment, the transfer device 24 is configured to apply tension force only to the skin sheet member 13A of the upper layer side sheet group. However, the upper layer side sheet group and the lower layer side sheet group may be molded with pressing by the press molding device with the upper layer side sheet group and the lower layer side sheet group being held with different forces. For instance, different tension forces may be applied to the upper layer side sheet group and the lower layer side sheet group or the force of holding the sheet members and the direction in which the sheet members are held may differ.

The present technology is not necessarily applied to a ceiling member of a vehicle as the laminate sheet. The laminate sheet of the present technology may be applied to an interior component of an automobile or a vehicle having a laminated structure other than the ceiling member. Furthermore, the present technology is not limited to the vehicular interior component but may be widely applied for producing of a laminate sheet obtained by stacking and molding sheet members.

1. A method of producing a laminate sheet comprising:
supplying sheet members in a first transfer direction to a supply position where the sheet members are arranged in an upper bottom direction;
separately holding an upper layer side sheet group including at least one of the sheet members that is on an upper layer side and a lower layer side sheet group including at least another one of the sheet members that is on a lower layer side than the upper layer side sheet group;
pulling the upper layer side sheet group in the first transfer direction from the supply position to a position above a table separator of a table and pulling the lower layer side sheet group in the first transfer direction from the supply position to a position below the table separator at a same time and spreading the sheet members including the upper layer side sheet group and the lower layer side sheet group on the table with the table separator being in a space between the upper layer side sheet group and the lower layer side sheet group;
moving a transfer device toward the table in a second transfer direction that is an opposite direction from the first transfer direction;
according to the moving of the transfer device in the second transfer direction, moving a transfer device separator of the transfer device closer to the table separator and replacing the table separator with the transfer device separator;
transferring the upper layer side sheet group and the lower layer side sheet group in the first direction from the table to a press molding device with the transfer device holding an edge portion of the upper layer side sheet group and an edge portion of the lower layer side sheet group separately; and
press molding the upper layer side sheet group and the lower layer side sheet group with the upper layer side sheet group and the lower layer side sheet group being held by the transfer device with different forces and molding a laminate sheet.

2. The method of producing a laminate sheet according to claim 1, wherein
in the moving of the transfer device separator, according to the moving of the transfer device in the second transfer direction, moving the transfer device separator closer to the table separator and moving the table separator out from the space and moving the transfer device separator into the space.

3. The method of producing a laminate sheet according to claim 1, wherein
in the moving of the transfer device separator, according to the moving of the transfer device in the second transfer direction, moving the transfer device separator closer to the table separator and moving the transfer device separator and the table separator in the second transfer direction with keeping a predefined distance therebetween.

4. The method of producing a laminate sheet according to claim 1, wherein
in the moving of the transfer device separator, according to the moving of the transfer device in the second transfer direction, moving the transfer device separator closer to the table separator and moving the table separator from an upper side of the table to a lower side of the table.

5. The method of producing a laminate sheet according to claim 1, wherein
after the replacing of the table separator with the transfer device separator, the upper layer side sheet group is above the transfer device separator and the lower layer side sheet group is below the transfer device separator.

6. The method of producing a laminate sheet according to claim 1, wherein in the supplying of the sheet members, some of the sheet members are supplied from rolls of the sheet members, and further comprising cutting the sheet members supplied from the rolls after or during the spreading and the pulling.

7. A laminate sheet producing device comprising:
a supply section configured to supply sheet members in a first transfer direction to a supply position where the sheet members are arranged in an upper-bottom direction;
a spreading device including
a table to which the sheet members are transferred from the supply section, the table including a table body, a table separator disposed above and spaced from the table body, and a separator moving device configured to move the table separator,
a first holding portion holding an upper layer side sheet group including at least one of the sheet members that is on an upper layer side at the supply position,
a second holding portion holding a lower layer side sheet group including at least another one of the sheet members that is below the upper layer side sheet group at the supply position, and
a moving device configured to move the first holding portion and the second holding portion at a same time and move the upper layer side sheet group in the first transfer direction to a position above the table separator and move the lower layer side sheet group in the first transfer direction to a position below the table separator at a same time, the table separator being in a space between the upper layer side sheet group and the lower layer side sheet group; and
a transfer device configured to be movable in the first transfer direction and a second transfer direction that is an opposite direction from the first transfer direction and to transfer the sheet members in the first transfer direction from the spreading device to a press molding device, the transfer device including
a transfer device separator,
an upper holding portion that holds the upper layer side sheet group above the transfer device separator, and
a lower holding portion that holds the lower layer side sheet group below the transfer device separator, wherein
according to movement of the transfer device in the second transfer direction toward the table, the table separator is moved by the separator moving device out of the space and the transfer device separator is moved into the space and the upper holding portion holds the upper layer side sheet group above the transfer device separator and the lower holding portion holds the lower layer side sheet group below the transfer device separator.

8. The laminate sheet producing device according to claim 7, wherein
the table separator includes two table separators on two edges of the table body with respect to a width direction that is perpendicular to the first transfer direction, and
edge portions of the upper layer side sheet group with respect to the width direction are disposed on the two table separators, respectively.

9. The laminate sheet producing device according to claim 7, wherein
the separator moving device includes a conveyer chain that extends an edge of the table body along the first transfer direction,
the table separator includes support members fixed to a portion of the conveyer chain at intervals, and
according to rotation of the conveyer chain, the support members are moved from a position above the table body to a position under the table body.

10. The laminate sheet producing device according to claim 7, wherein
the upper holding portion includes an upper jaw and an upper jaw receiver that hold the upper layer side sheet group therebetween,
the lower holding portion includes a lower jaw and a lower jaw receiver that hold the lower layer side sheet group therebetween, and
the upper jaw receiver and the lower jaw receiver are configured as the transfer device separator.

11. The laminate sheet producing device according to claim 7, wherein
according to the movement of the transfer device in the second transfer direction, the transfer device separator is moved closer to the table separator and the transfer device separator and the table separator are moved in the second direction with keeping a predefined distance therebetween.

12. The laminate sheet producing device according to claim 7, wherein
according to the movement of the transfer device in the second transfer direction, the transfer device separator is moved closer to the table separator and the table separator is moved from a position above the table body to a position under the table body

13. The laminate sheet producing device according to claim 9, wherein
the table separator includes support members fixed to the separator moving device,
the support members have a U shape that opens toward a middle of the table body with respect to the width direction, and
the support members include support portions that are above and spaced from the table body.
